(19) United States
(12) Patent Application Publication
(10) Pub. No.: US 2010/0127690 A1
(43) Pub. Date: May 27, 2010

(54) SEMICONDUCTOR APPARATUS

(75) Inventor: Koichi Endo, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/561,755

(22) Filed: Sep. 17, 2009

(30) Foreign Application Priority Data
Nov. 27, 2008 (JP) 2008-302694

(51) Int. Cl. H02J 1/00

(52) U.S. Cl. 323/318

(57) ABSTRACT

A semiconductor apparatus includes, a first switching device; a rectifying device; a control circuit controlling the first switching device; a first driving terminal; a first interconnection connecting the first switching device to the first driving terminal; and a second interconnection. The second interconnection is disposed to connect the rectifying device to the first driving terminal, and the second interconnection has a mutual inductance with the first interconnection.

### CROSS-REFERENCE TO RELATED APPLICATIONS

This application is based upon and claims the benefit of priority from the prior Japanese Patent Application No. 2008-302694, filed on Nov. 27, 2008; the entire contents of which are incorporated herein by reference.

### BACKGROUND OF THE INVENTION

1. Field of the Invention

The present invention relates to a semiconductor apparatus.

2. Background Art

Switching circuits including two switching devices of high and low side are used in drive circuits and the like to drive inductive loads such as DC-DC converters and motors.

A control circuit controls by alternately switching the switching devices ON and OFF to store and maintain energy necessary for the inductive load.

Frequencies and currents for such switching circuits tend to increase, because smaller devices and higher efficiencies are required.

Therefore, devices and circuits are improved. Proposals have been made also regarding mounting on the semiconductor chip (for example, refer to JP-A 2004-342735 (Kokai)).

### SUMMARY OF THE INVENTION

According to an aspect of the invention, there is provided a semiconductor apparatus including, a first switching device; a rectifying device; a control circuit controlling the first switching device; a first driving terminal; a first interconnection connecting the first switching device to the first driving terminal; and a second interconnection disposed to connect the rectifying device to the first driving terminal, the second interconnection having a mutual inductance with the first interconnection.

### BRIEF DESCRIPTION OF THE DRAWINGS

FIG. 1 is a schematic view illustrating the configuration of a DC-DC converter using a semiconductor apparatus according to a first embodiment of the present invention;

FIG. 2 is a schematic view illustrating another configuration of the semiconductor apparatus according to the first embodiment of the present invention;

FIG. 3 is a schematic plan view illustrating the configuration of electrode portions of the switching devices illustrated in FIG. 2;

FIG. 4 is a schematic view illustrating the configuration of a semiconductor apparatus of a comparative example;

FIG. 5 is a schematic plan view illustrating the configuration of electrode portions of the switching devices illustrated in FIG. 4;

FIGS. 6A to 6C are circuit diagrams illustrating the operations of a DC-DC converter using the semiconductor apparatus of the comparative example;

FIG. 7 is a graph showing a characteristic of a diode of a comparative example;

FIG. 8 is a schematic view illustrating the operations of the semiconductor apparatus illustrated in FIG. 2;

FIG. 9 is a schematic plan view illustrating the configuration of a portion enclosed by a broken line A of the electrode portions of the switching devices illustrated in FIG. 3;

FIG. 10 is a schematic view illustrating the configuration of electrode portions of the switching devices illustrated in FIG. 3;

FIG. 11 is a schematic plan view illustrating the current paths of the electrode portions illustrated in FIG. 10;

FIG. 12 is a schematic view illustrating another configuration of electrode portions of the switching devices illustrated in FIG. 3;

FIG. 13 is a schematic plan view illustrating the current paths of the electrode portions of the switching devices illustrated in FIG. 12;

FIG. 14 is a schematic plan view illustrating another configuration of electrode portions of the switching devices of the integrated circuit (the semiconductor apparatus) illustrated in FIG. 2;

FIG. 15 is a schematic view illustrating the configuration of a semiconductor apparatus according to a second embodiment of the present invention;

FIG. 16 is a schematic view illustrating another configuration of the semiconductor apparatus according to the second embodiment of the present invention;

FIG. 17 is a circuit diagram illustrating the configuration of a DC-DC converter using a semiconductor apparatus according to a third embodiment of the present invention; and

FIG. 18 is a circuit diagram illustrating the configuration of a motor control circuit using a semiconductor apparatus according to a fourth embodiment of the present invention.

### DETAILED DESCRIPTION OF THE INVENTION

Embodiments of the present invention will now be described in detail with reference to the drawings.

The drawings are schematic or conceptual. Relationships between thickness and width of portions, and proportions of sizes among portions, etc., are not necessarily the same as actual values thereof. Further, dimensions and proportions may be illustrated differently among drawings, even for identical portions.

In this specification and drawings, components similar to those described or illustrated in a drawing thereinabove are marked with like reference numerals, and a detailed description is omitted as appropriate.

### First Embodiment

FIG. 1 is a schematic view illustrating the configuration of a DC-DC converter using a semiconductor apparatus (a portion enclosed by a broken line) according to a first embodiment of the present invention.

A DC-DC converter 80, illustrated in FIG. 1 (illustrated as a voltage step-down converter in the drawing), includes a semiconductor apparatus 70, a coil H1, and a capacitor C1 and supplies a voltage to a load. The load is represented by a load resistor R1 in FIG. 1.

One end of the coil H1 connects to an external terminal Lout of the semiconductor apparatus 70. Another end of the coil H1 is terminated by the capacitor C1 and the load resistor R1.

The DC-DC converter 80 is a voltage step-down DC-DC converter and outputs an output Vout lower than an input Vin by alternately switching ON and OFF a first switching device Q1 and a second switching device Q2 included in the semiconductor apparatus 70.

The semiconductor apparatus 70 includes the external terminal Lout, an integrated circuit 60 (semiconductor apparatus), a third interconnection 41, and a package 90. The third interconnection 41 electrically connects a bonding pad PL1 (first driving terminal) of the integrated circuit 60 described below to the external terminal Lout exposed to an exterior of the package 90. The third interconnection 41 is formed of, for example, a bonding wire. The semiconductor apparatus 70 has a structure in which the package 90 contains the external terminal Lout, the integrated circuit 60, and the third interconnection 41 by, for example, sealing in resin or sealing in a can, ceramic housing, etc.

The external terminal Lout of the semiconductor apparatus 70 is electrically connected to a connection point between the first switching device Q1 and the second switching device Q2 connected in series. The external terminal Lout is electrically connected to the input Vin when the first switching device Q1 is switched ON. The external terminal Lout is electrically connected to ground when the second switching device Q2 is switched ON.

The external terminal Lout supplies energy to the load resistor R1 via the coil H1 to provide the output Vout. The capacitor C1 and the coil H1 form a low pass filter to smooth the output Vout. The output Vout may be provided as feedback (not illustrated) to the semiconductor apparatus 70 to control the output Vout.

The integrated circuit 60 has a one-chip structure including the first switching device Q1, the second switching device Q2, a control circuit 10, the bonding pad PL1 (the first driving terminal), a first interconnection 21, and a second interconnection 22 formed on the same semiconductor substrate.

The integrated circuit 60 illustrated in FIG. 1 may include other circuits, devices, and interconnections.

The control circuit 10 controls alternately switching ON and OFF of the first switching device Q1 and the second switching device Q2 to store and maintain a necessary energy in the coil H1.

FIG. 1 illustrates that the first switching device Q1 is a p-type MOSFET including a source Q1S, a gate Q1G, a drain Q1D, and a not-illustrated channel. Similarly, the second switching device Q2 is an n-type MOSFET including a source Q2S, a gate Q2G, a drain Q2D, and a not-illustrated channel. The first switching device Q1 and the second switching device Q2 has a parasitic diodes D1 and D2.

The integrated circuit 60 includes bonding pads PV and PG. The bonding pad PV is electrically connected to the source Q1S of the first switching device Q1 by a interconnection 31. The bonding pad PG is electrically connected to the source Q2S of the second switching device Q2 by a interconnection 32. The bonding pad PV is electrically connected to the power source terminal Vin of the semiconductor apparatus 70 by, for example, a bonding wire. Similarly, the bonding pad PG is electrically connected to a ground terminal GND of the semiconductor apparatus 70.

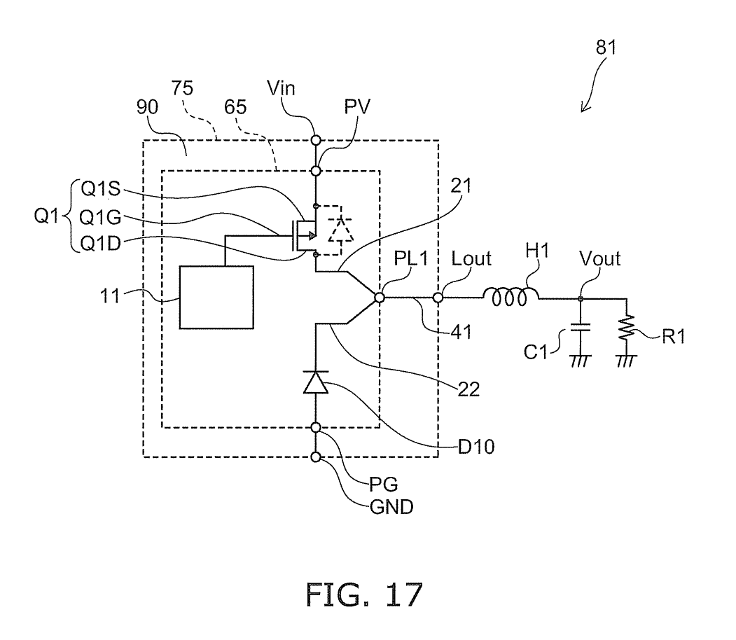

The first switching device Q1 and the second switching device Q2 are not limited to those of this example and may include other devices, e.g., n-type MOSFETs used together, p-type MOSFETs used together, a BJT, an IGBT, or a bipolar transistor. As described below, the present invention is based on the reverse recovery characteristics of the PN junction of the parasitic diode D2, etc., of the second switching device Q2. In addition to such active devices, the second switching device may use a PN junction diode, a Schottky barrier diode, and the like. However, problems are fewer in the case where a Schottky barrier diode is used. As described below in regard to FIG. 17, the second switching device Q2 can be replaced with a rectifying device such as a PN junction diode.

As illustrated in FIG. 1, the drain Q1D of the first switching device Q1 is electrically connected to the bonding pad PL1 (the first driving terminal) by the first interconnection 21. The drain Q2D of the second switching device Q2 is electrically connected to the bonding pad PL1 (the first driving terminal) by the second interconnection 22.

In particular, the first interconnection 21 includes a interconnection 21a, i.e., a portion independent of the second interconnection 22, and a interconnection 21b, i.e., a portion connected to the bonding pad PL1 (the first driving terminal). Similarly, the second interconnection 22 includes a interconnection 22a, i.e., a portion independent of the first interconnection 21, and a interconnection 22b, i.e., a portion connected to the bonding pad PL1 (the first driving terminal).

The interconnection 21a electrically connects the drain Q1D of the first switching device Q1 to a first relay point PL1a. The interconnection 21b electrically connects the first relay point PL1a to the bonding pad PL1 (the first driving terminal). Similarly, the interconnection 22a electrically connects the drain Q2D of the second switching device Q2 to a second relay point PL2a. The interconnection 22b electrically connects the second relay point PL2a to the bonding pad PL1 (the first driving terminal).

The first interconnection 21 or at least a portion thereof and the second interconnection 22 or at least a portion thereof are provided proximally to each other such that the mutual inductance increases.

Thereby, a reverse voltage is produced to suppress the cross current. The reverse voltage is proportional to the temporal change of a current (cross current) flowing through the path of the power source terminal Vin, the first switching device Q1, the parasitic diode D2, and the ground terminal GND. The details are described below.

According to this example, a semiconductor apparatus can be provided having reduced energy losses of the switching circuit controlling the inductive load.

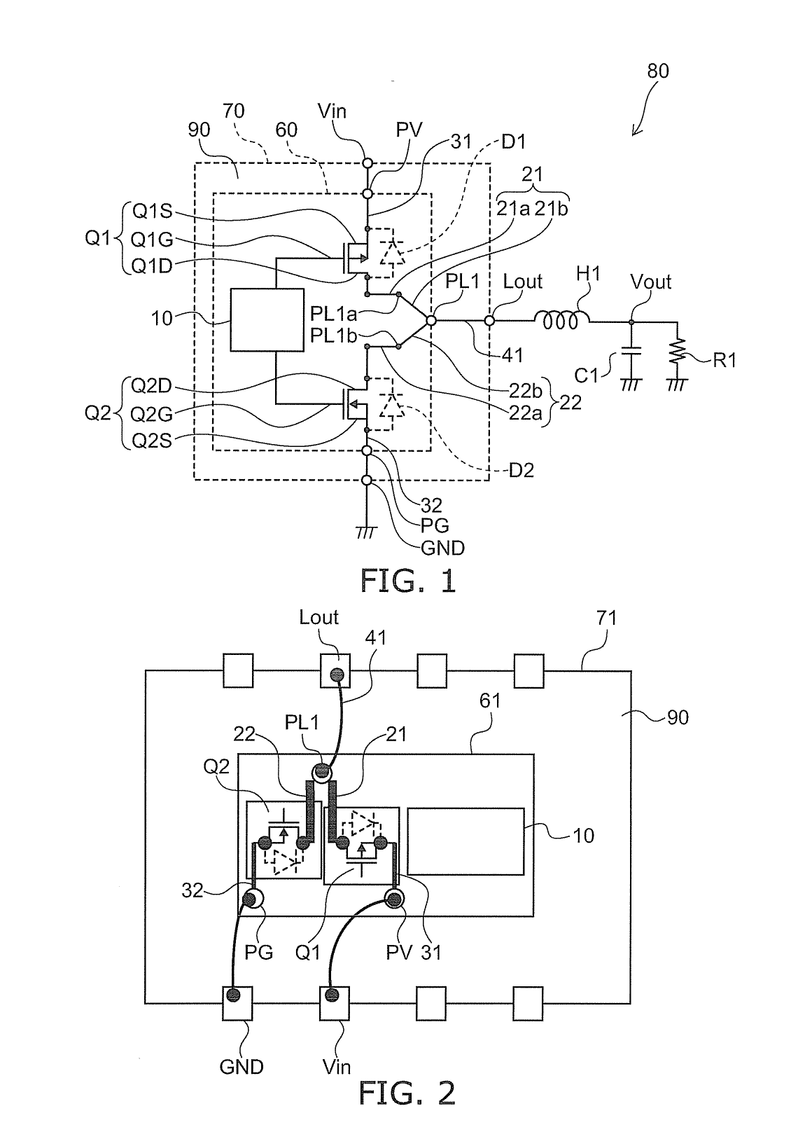

FIG. 2 is a schematic view illustrating another configuration of the semiconductor apparatus according to the first embodiment of the present invention.

In an integrated circuit 61 (semiconductor apparatus) sealed in a semiconductor apparatus 71 illustrated in FIG. 2, the drain of the first switching device Q1 and the drain of the second switching device Q2 are disposed proximally to each other.

The integrated circuit 61 includes the first interconnection 21 electrically connecting the drain of the first switching device Q1 to the bonding pad PL1 (the first driving terminal). The integrated circuit 61 also includes the second interconnection 22 electrically connecting the drain of the second switching device Q2 to the bonding pad PL1 (the first driving terminal).

The first interconnection 21 and the second interconnection 22 of the integrated circuit 61 are disposed substantially parallel to each other. In other words, the interconnections 21 and 22 are provided substantially parallel to each other. Thereby, a mutual inductance M₁₂ between the first interconnection 21 and the second interconnection 22 can be increased. Otherwise, the semiconductor apparatus 71 is similar to the semiconductor apparatus 70, and a description is omitted.

When the mutual inductance M₁₂ between the first interconnection 21 and the second interconnection 22 increase, a reverse voltage proportional to the temporal change of the cross current is produced. The cross current can be suppressed. The details are described below.

According to this example, a semiconductor apparatus reduces energy losses of the switching circuit controlling the inductive load.

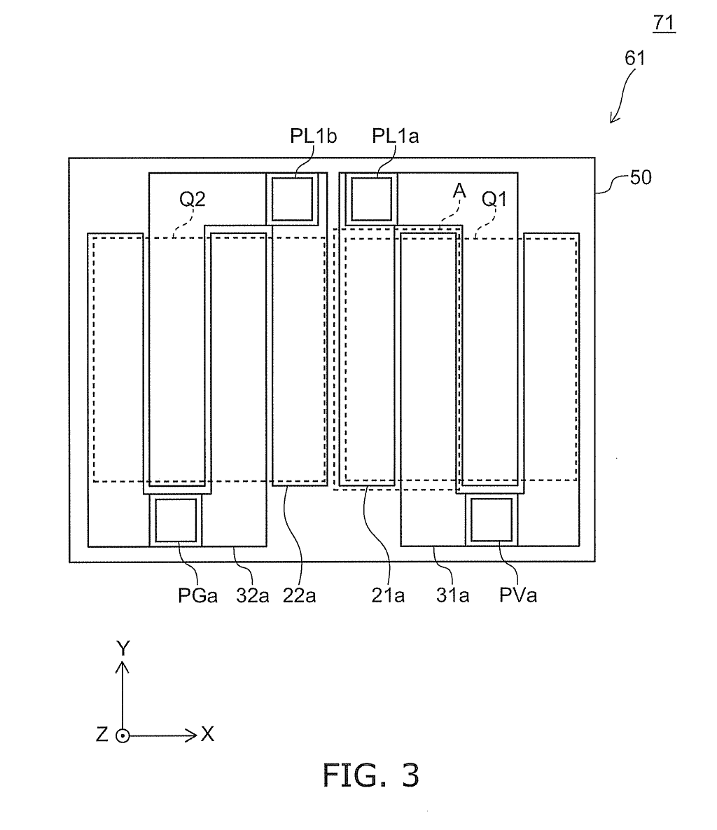

FIG. 3 is a schematic plan view illustrating the configuration of electrode portions of the switching devices illustrated in FIG. 2.

As illustrated in FIG. 3, the first switching device Q1 and the second switching device Q2 are disposed symmetrically to each other.

A plane parallel to the electrode portions is assumed to be an XY plane. An axis of symmetry centered between the first switching device Q1 and the second switching device Q2 is assumed to be a Y axis. A direction perpendicular to the Y axis from the second switching device Q2 toward the first switching device Q1 is assumed to be an X axis.

The interconnection 21a is provided on the first switching device Q1 (the portion enclosed by the broken line Q1) formed on a substrate 50 to electrically connect the drain of the first switching device Q1 to the relay point PL1a. The interconnection 21b (not illustrated) electrically connects the relay point PL1a to the bonding pad PL1 (the first driving terminal). Similarly, the interconnection 22a is provided on the second switching device Q2 (the portion enclosed by the broken line Q2) formed on the substrate 50 to electrically connect the drain of the second switching device Q2 to the relay point PL1b. The interconnection 22b (not illustrated) electrically connects the relay point PL1b to the bonding pad PL1 (the first driving terminal). The interconnection 21a and the interconnection 21b (not illustrated) combine to form the first interconnection 21. The first interconnection 21 electrically connects the drain of the first switching device Q1 to the bonding pad PL1 (the first driving terminal).

Similarly, the second interconnection 22 is provided with the interconnection 22a and the interconnection 22b (not illustrated). The second interconnection 22 electrically connects the drain of the second switching device Q2 to the bonding pad PL1 (the first driving terminal).

A interconnection 31a electrically connects a relay point PVa to the source of the first switching device Q1. A interconnection 31b electrically connects the relay point PVa to the bonding pad PV (not illustrated). The interconnection 31 is provided with the interconnection 31a and the interconnection 31b.

The source of the first switching device Q1 is thereby electrically connected to the bonding pad PV. The bonding pad PV and the power source terminal Vin are electrically connected by, for example, a bonding wire (not illustrated).

Similarly, a interconnection 32a electrically connects a relay point PGa to the source of the second switching device Q2. A interconnection 32b electrically connects the relay point PGa to the bonding pad PG (not illustrated). The interconnection 32 is provided with the interconnection 32a and the interconnection 32b.

The source of the second switching device Q2 is thereby electrically connected to the bonding pad PG. The bonding pad PG is electrically connected to the ground terminal GND by, for example, a bonding wire (not illustrated).

The interconnection 21a has a U-shape opening toward a negative direction of the Y axis. The interconnection 31a has a U-shape opening toward a positive direction of the Y axis. These interconnections are provided to mesh with each other in the same plane. The interconnection 22a and the interconnection 32a are similarly provided at positions symmetric with respect to the Y axis.

Although each of the interconnections 21a, 31a, 22a, and 32a illustrated in FIG. 3 is U-shaped, the present invention is not limited thereto. It is sufficient that the interconnections 21a and 22a are proximal and disposed substantially parallel to each other. For example, configurations according to the current capacity are possible in which I-shapes, L-shapes, or other configurations are disposed substantially parallel to each other. The first switching device Q1 and the second switching device Q2 may have different configurations.

As recited above, the interconnection 21a and the interconnection 22a are formed symmetrically with respect to the Y axis and parallel to each other in the Y direction. The mutual inductance between the interconnections is thereby increased. The mutual inductance M₁₂ between the first interconnection 21 and the second interconnection 22 can be further increased by making the interconnection 21b and the interconnection 22b more proximal.

A reverse voltage proportional to the temporal change of the cross current is thereby produced, and the cross current can be suppressed. The details are described below.

According to this example, a semiconductor apparatus reduces energy losses of the switching circuit controlling the inductive load.

The principle of suppressing the cross current by increasing the mutual inductance M₁₂ between the first interconnection 21 and the second interconnection 22 will now be described.

First, the causes of energy losses of the switching circuit controlling the inductive load will be described using a DC-DC converter as an example.

### Comparative Example

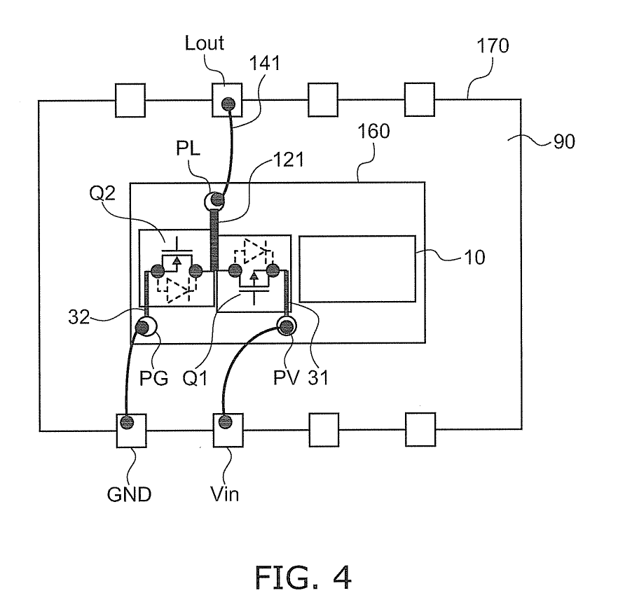

FIG. 4 is a schematic view illustrating the configuration of a semiconductor apparatus of a comparative example.

A semiconductor apparatus 170 of the comparative example illustrated in FIG. 4 includes an external terminal Lout, an integrated circuit 160, a interconnection 141, and a package 90. The interconnection 141 made of, for example, a bonding wire electrically connects a bonding pad PL of the integrated circuit 160 described below to the external terminal Lout exposed to the exterior. The semiconductor apparatus 170 has a structure in which the external terminal Lout, the integrated circuit 160, and the interconnection 141 are sealed in resin in the package 90.

Similarly to the semiconductor apparatus 70 illustrated in FIG. 1, the semiconductor apparatus 170 can be used as a DC-DC converter by being connected to the not-illustrated coil H1, capacitor C1, and load resistor R1.

The integrated circuit 160 has a one-chip structure including a first switching device Q1, a second switching device Q2, a control circuit 10, the bonding pad PL, and a interconnection 121 formed on the same semiconductor substrate.

A drain of the first switching device Q1 and a drain of the second switching device Q2 (the drain of the p-type MOSFET and the drain of the n-type MOSFET of FIG. 4) are connected to the common bonding pad PL by the interconnection 121 on the integrated circuit 160.

The bonding wire of the interconnection 141 connects the bonding pad PL to the external terminal Lout of the semiconductor apparatus 170. Although the interconnection 141 may include multiple connections arranged in parallel or a metal plate configuration to reduce the resistance, the interconnection 121 connects the two switching devices Q1 and Q2 on the chip. The purpose of such a configuration is to reduce the chip surface area and reduce the surface area of the bonding pad to reduce costs. Otherwise, the semiconductor apparatus 170 is similar to semiconductor apparatus 71 illustrated in FIG. 2, and a description is omitted.

In other words, the integrated circuit 160 is sealed in the semiconductor apparatus 170 of the comparative example. The first interconnection 21 and the second interconnection 22 of the integrated circuit 61 sealed in the semiconductor apparatus 71 illustrated in FIG. 2 is replaced by one interconnection 121 in the integrated circuit 160.

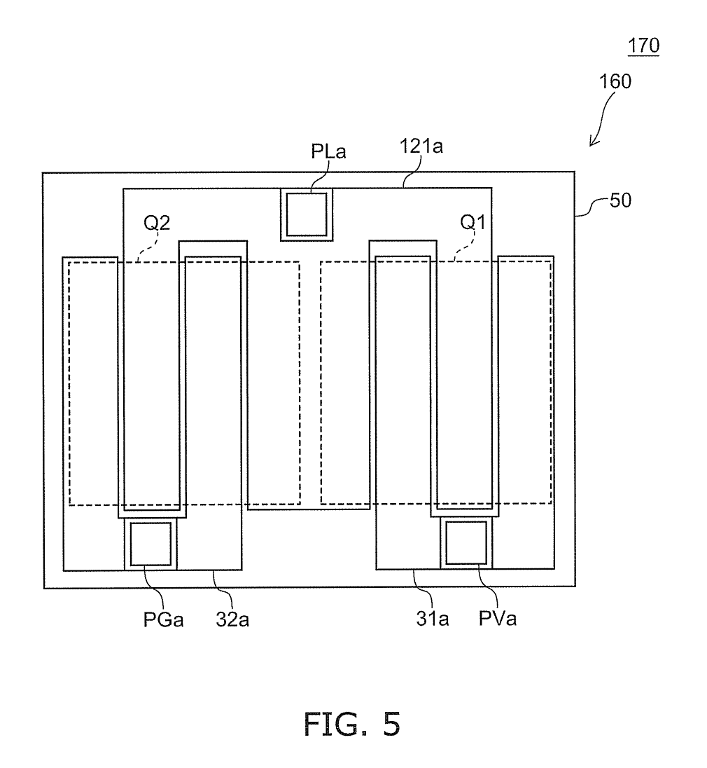

A portion of the interconnection 121 is formed of a single E-shaped interconnection portion 121a illustrated in FIG. 5. That is, the interconnection 121 is formed of the interconnection 121a to the relay point PLa and a interconnection from the relay point PLa to the bonding pad PL.

Therefore, a cross current flows from the first switching device Q1 toward the parasitic diode D2 of the second switching device Q2 via the interconnection 121, and energy losses occur.

The operations of a DC-DC converter using the semiconductor apparatus 170 of the comparative example will now be described. In particular, the case where a cross current occurs will be described in detail. That is, the series of state transitions will be described in detail. The state transition are from the state where the first switching device Q1 is OFF and the second switching device Q2 is ON, to the state where the first switching device Q1 and the second switching device Q2 both are switched OFF, to the state where the first switching device Q1 is switched ON. Meanwhile, the coil H1 continually supplies current to the load resistor R1.

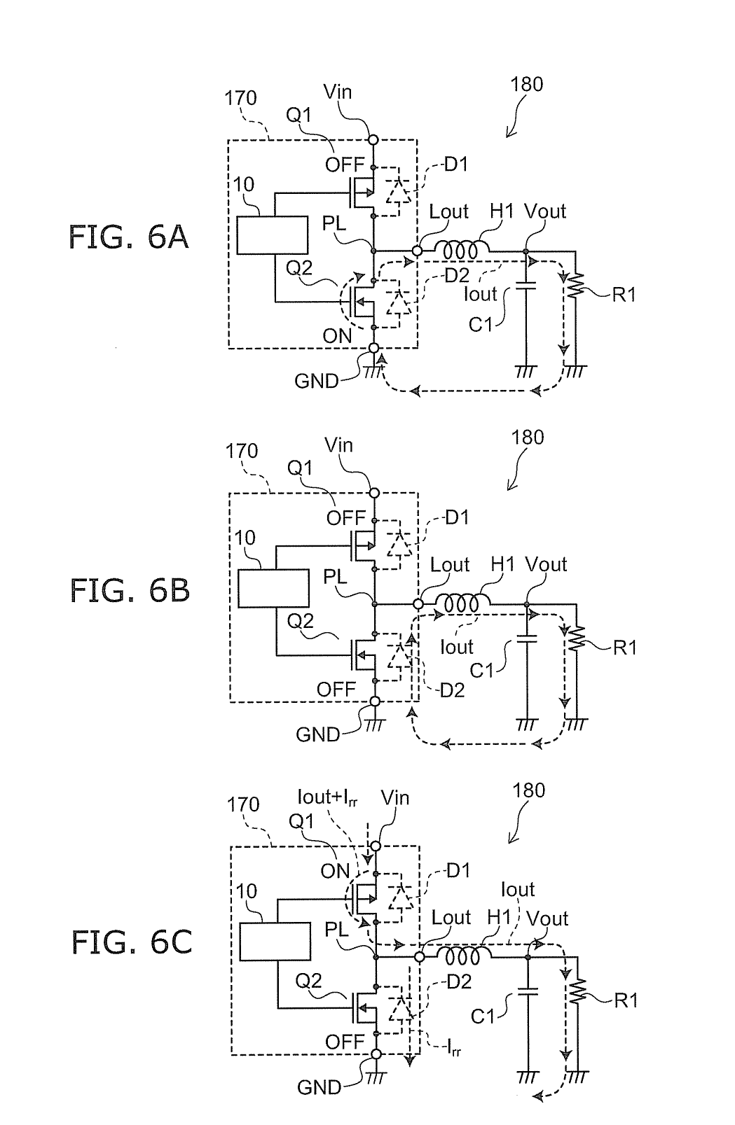

FIGS. 6A to 6C are circuit diagrams illustrating the operations of a DC-DC converter 180 using the semiconductor apparatus 170 of the comparative example.

FIG. 6A illustrates the state where the first switching device Q1 is OFF and the second switching device Q2 is ON.

FIG. 6B illustrates the state where the first switching device Q1 is OFF and the second switching device Q2 is OFF.

FIG. 6C illustrates the state where the first switching device Q1 is ON and the second switching device Q2 is OFF.

The DC-DC converter 180 starts in the state where the first switching device Q1 is ON and the second switching device Q2 is OFF. The external terminal Lout is electrically connected to the power source terminal Vin via the first switching device Q1, current flows in the coil H1, and the output Vout increases.

When energy has been stored in the coil H1 and the energy has increased enough to supply the necessary current to the load resistor R1, the control circuit 10 cuts off the path supplying the current from the power source to the coil H1 by switching OFF the first switching device Q1.

The energy stored in the coil H1 is supplied toward the load resistor R1 even while the first switching device Q1 is OFF. The current (the regenerative current) during this interval flows from the ground terminal GND through the parasitic diode D2 of the second switching device Q2 toward the coil H1. Subsequently, the state transitions to where the first switching device Q1 is OFF and the second switching device Q2 is ON, that is, the state illustrated in FIG. 6A.

A regenerative current Tout flows through the path of the ground terminal GND, the second switching device Q2, the coil H1, and the load resistor R1 (the direction of the broken-line arrow) as illustrated in FIG. 6A.

The regenerative current flows even when the second switching device Q2 is not switched ON due to the parasitic diode D2. However, if the second switching device Q2 is a device controllable as illustrated in FIGS. 6A to 6C, the second switching device Q2 is switched ON to recover the current as illustrated in FIG. 6A to reduce the energy losses due to the parasitic diode D2.

As the energy of the coil H1 decreases and the regenerative current Tout flowing through the load resistor R1 decreases, the voltage across the load resistor, i.e., the output Vout, drops. The first switching device Q1 must once again be switched ON to supply energy to the coil H1 to maintain the output Vout.

However, in the case where the first switching device Q1 is switched ON in the state where the second switching device Q2 is ON, a current path (cross current) occurs from the power source terminal Vin toward the ground terminal GND and a large energy loss is undesirably produced. Therefore, the second switching device Q2 is switched OFF as illustrated in FIG. 6B prior to switching the first switching device Q1 ON.

At this time, the regenerative current Tout continues to flow through the parasitic diode D2 of the second switching device Q2 (the path of the broken-line arrow of FIG. 6B). In the case where the second switching device Q2 includes an IGBT or a BJT, it is necessary to make a similar current path by actually connecting a diode in parallel with the second switching device Q2 because the parasitic diode D2 cannot be connected as illustrated in FIG. 6B. In other words, a parasitic diode or an actual diode is connected as a rectifying device in parallel with the second switching device Q2.

Then, when the first switching device Q1 is switched ON as illustrated in FIG. 6C, energy is supplied from the power source terminal Vin to the coil H1, and the current Iout to the load resistor R1 is maintained.

Here, when the state illustrated in FIG. 6B transitions to the state illustrated in FIG. 6C, problems arise due to the applied voltage change when the forward bias of the PN junction diode D2 (the parasitic diode) carrying the regenerative current Iout in the second switching device Q2 switches to a reverse bias.

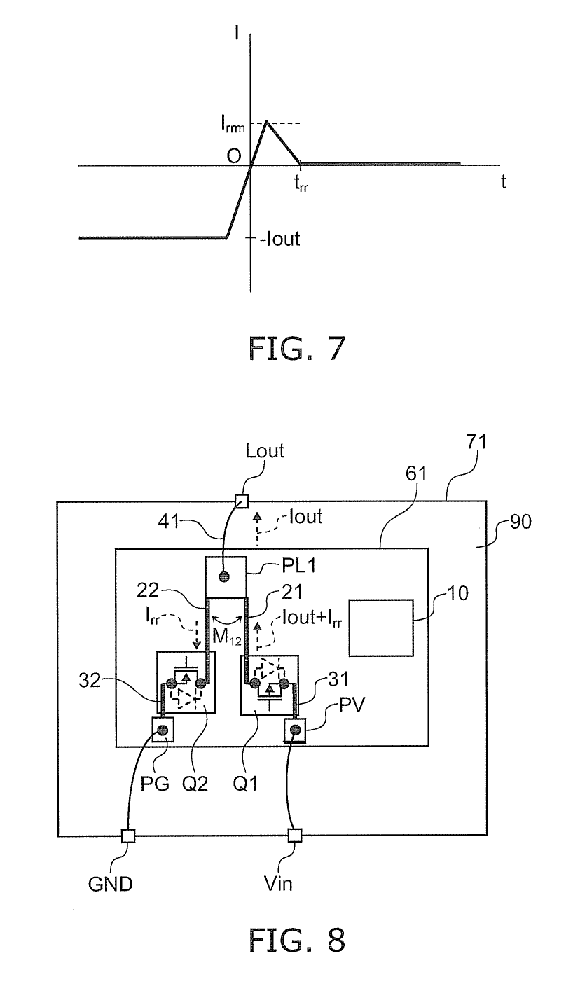

PN junction diodes have reverse recovery characteristics. For example, such a characteristic is illustrated schematically in FIG. 7.

FIG. 7 schematically illustrates a current I of a PN junction diode over a time t, where the state changes from a forward bias to a reverse bias when t=0. Here, a positive current I is a current in the reverse bias direction.

Even when the bias is switched from the forward direction to the reverse direction as illustrated in FIG. 7, a reverse recovery current Iᵣᵣ (with a maximum value Iᵣᵣₘ) flows in the reverse direction until excess carriers Qᵣᵣ stored in the diode interior are discharged (assuming Qᵣᵣ=Qᵣᵣₘ at t=0). A time tᵣᵣ, i.e., a time until the excess carriers Qᵣᵣ are discharged and the reverse recovery current switches OFF, depends on the reverse recovery current Iᵣᵣ and the excess carriers Qᵣᵣ.

As illustrated in FIG. 6C, the reverse recovery current Iᵣᵣ flows from the power source terminal Vin through the first switching device Q1 and from the parasitic diode D2 of the second switching device Q2 toward the ground terminal GND. This cross current (the reverse recovery current) Iᵣᵣ flows from the power source toward ground and therefore undesirably results in an energy loss. In the case of a DC-DC converter, the energy loss undesirably appears as an efficiency decrease.

Particularly in the case of the comparative example illustrated in FIG. 5 where the drains of the two adjacently disposed switching devices Q1 and Q2 are wired by a single electrode, the cross current (the reverse recovery current) Iᵣᵣ flows over the shortest distance, and the energy loss increases.

The two switching devices Q1 and Q2 may be mounted in a monolithic configuration or in the same package including multiple chips. The cross current (the reverse recovery current) Iᵣᵣ is problematic in both cases.

Once again turning to FIG. 7, the reverse recovery current Iᵣᵣ will now be considered.

The excess carriers Qᵣᵣₘ have a limited lifetime and decrease by pair annihilation in addition to the reverse recovery current Iᵣᵣ.

It is possible to shorten the lifetime of the carriers by doping the PN junction diode with, for example, gold. However, in the case of switching circuits such as those of the semiconductor apparatuses 70 and 170, such measures also affect the other devices such as the switching devices, and it is difficult to shorten the carrier lifetime.

On the other hand, an integral value Q of the reverse recovery current Iᵣᵣ over the time t is smaller than the value Qᵣᵣₘ of the excess carriers Qᵣᵣ at t=0 due to the lifetime of the excess carriers Qᵣᵣ. The difference between the excess carriers Qᵣᵣₘ and the integral value Q increases as the time tᵣᵣ, i.e., the time until the reverse recovery current Iᵣᵣ switches OFF, lengthens.

Therefore, the energy loss due to the cross current (the reverse recovery current) Iᵣᵣ in the state illustrated in FIG. 6C can be reduced by suppressing the maximum value Iᵣᵣₘ of the reverse recovery current and lengthening the time tᵣᵣ.

Therefore, in the semiconductor apparatuses 70 and 71 of this example illustrated in FIG. 1 to FIG. 3, the interconnection from the two switching devices Q1 and Q2 to the bonding pad PL1 (the first driving terminal) of the integrated circuits 60 and 61 is divided into the first interconnection 21 and the second interconnection 22, respectively.

A reverse voltage proportional to the mutual inductance M₁₂ is produced by the mutual inductance M₁₂ between the first interconnection 21 and the second interconnection 22 and can suppress the cross current (the reverse recovery current) Iᵣᵣ.

FIG. 8 is a schematic view illustrating the operations of the semiconductor apparatus illustrated in FIG. 2.

In the integrated circuit 61 sealed in the semiconductor apparatus 71 illustrated in FIG. 8, the mutual inductance M₁₂ occurs between the first interconnection 21 and the second interconnection 22 through which the cross current (the reverse recovery current) Iᵣᵣ flows. The third interconnection 41 connecting the external terminal Lout of the semiconductor apparatus 71 to the bonding pad PL1 of the integrated circuit 61 is made of, for example, bonding wire. Here, a mutual inductance M₁₃ between the first interconnection 21 and the third interconnection 41 and a mutual inductance M₂₃ between the second interconnection 22 and the third interconnection 41 are small compared to the mutual inductance M₁₂.

The sum of the output current Iout and the cross current (the reverse recovery current) Iᵣᵣ, i.e., a current of Iout+Iᵣᵣ, flows in the first interconnection 21. The current of Iout+Iᵣᵣ produces a reverse electromotive force of M₁₂·d(Iout+Iᵣᵣ)/dt in the second interconnection 22 and impedes the current Iᵣᵣ in the second interconnection 22. The current Iᵣᵣ flowing in the second interconnection 22 produces a reverse electromotive force of M₁₂·dIᵣᵣ/dt in the first interconnection 21 and impedes the current in the first interconnection 21.

The cross current (the reverse recovery current) Iᵣᵣ corresponds to the case where the current Iᵣᵣ flows in a circuit having a self-inductance of 2·M₁₂, producing a reverse electromotive force of 2·M₁₂·dIᵣᵣ/dt to impede the cross current (the reverse recovery current) Iᵣᵣ. However, the self-inductance component of each of the first interconnection 21 and the second interconnection 22 is ignored.

Considering the case where the current in the first switching device Q1 increases linearly from zero to Iout+Iᵣᵣₘ over a time δt, the change of the current flowing in the first interconnection 21 from zero to Iout+Iᵣᵣₘ produces a reverse electromotive force of about M₁₂·(Iout+Iᵣᵣₘ)/δt on the cross current (the reverse recovery current) Iᵣᵣ flowing in the parasitic diode D2 of the second switching device Q2 to impede the cross current (the reverse recovery current) Iᵣᵣ.

Therefore, the maximum value Iᵣᵣₘ of the cross current (the reverse recovery current) Iᵣᵣ is suppressed more than in the case without the reverse electromotive force. At this time, the time tᵣᵣ increases and the time integral value Q of the cross current (the reverse recovery current) Iᵣᵣ may be considered to be constant. However, as recited above, the integral value Q also decreases more than in the case without the reverse electromotive force because the excess carriers Qᵣᵣ of the parasitic diode D2 decrease due to pair annihilation. Therefore, the energy losses as an entirety can be reduced.

In other words, in addition to pair annihilation, the excess carriers Qᵣᵣ are discharged as current carriers to produce the cross current (the reverse recovery current) Iᵣᵣ leading to energy losses. By limiting the cross current (the reverse recovery current) Iᵣᵣ by the mutual inductance M₁₂ between the interconnections, the excess carriers Qᵣᵣ stored in the device vanish due to pair annihilation prior to being discharged as current carriers. The carriers that vanish do not result in energy losses.

Accordingly, the excess carriers Qᵣᵣ vanish while the current is limited by the mutual inductance M₁₂ between the interconnections without shortening the pair annihilation time by controlling the carrier lifetime, etc. The energy losses can therefore be reduced.

Similarly, in the case where the current flowing in the second interconnection 22 changes linearly from zero to Iᵣᵣₘ, a reverse electromotive force of about M₁₂·Iᵣᵣₘ/δt is produced in the first interconnection 21 to impede the cross current (the reverse recovery current) Iᵣᵣ.

A reverse electromotive force of about 2·M₁₂·Iᵣᵣₘ/βt is produced in the first interconnection 21 and the second interconnection 22 to impede the cross current (the reverse recovery current) Iᵣᵣ.

As recited above, the mutual inductance M₁₂ between the first interconnection 21 and the second interconnection 22 also produces the reverse electromotive force of M₁₂·dIout/dt in the second interconnection 22 proportional to the temporal change of the output current Tout flowing in the first interconnection 21. Therefore, the mutual inductance M₁₂ cannot be increased limitlessly.

A reverse electromotive force also occurs proportionally to the temporal change of the output current Iout flowing through the third interconnection 41. It is necessary that both of the mutual inductances M₁₃ and M₂₃ between the third interconnection 41 and the first and second interconnections 21 and 22 are smaller than the mutual inductance M₁₂.

Each interconnection also has a reverse electromotive force due to self-inductance.

However, due to increasing currents and frequencies of switching circuits, it is desirable that the parasitic impedance including the self-inductance is small. To this end, it is necessary that each interconnection is thick and short and only the mutual inductance M₁₂ between the first interconnection 21 and the second interconnection 22 is large.

Returning once again to the semiconductor apparatus 70 according to the first embodiment of the present invention illustrated in FIG. 1, the first interconnection 21 and the second interconnection 22 are connected to the bonding pad PL1 (the first driving terminal) via the relay points PL1a and PL1b, respectively, such that the mutual inductance M₁₂ therebetween increases.

In the semiconductor apparatus 71 illustrated in FIGS. 2 and 3, the first interconnection 21 or at least a portion thereof and the second interconnection 22 or at least a portion thereof are provided substantially parallel to each other to further increase the mutual inductance M₁₂.

Thus, the mutual inductance M₁₂ between the first interconnection 21 and the second interconnection 22 of the semiconductor apparatuses 70 and 71 according to the first embodiment of the present invention produce a reverse voltage proportional to the mutual inductance M₁₂ and can suppress the cross current (the reverse recovery current) Iᵣᵣ.

The semiconductor apparatuses 70 and 71 reduce energy losses of the switching circuit controlling the inductive load.

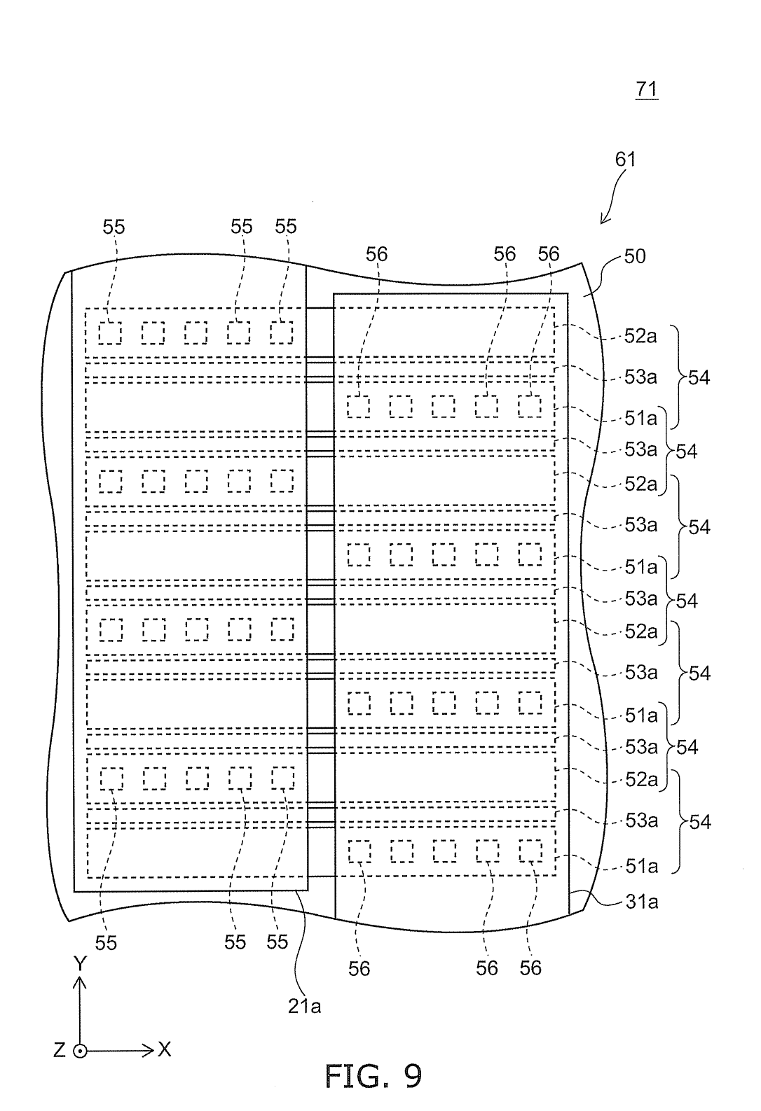

FIG. 9 is a schematic plan view illustrating the configuration of a portion enclosed by a broken line A of the electrode portions of the switching devices illustrated in FIG. 3.

As illustrated in FIG. 9, the electrode portions may include the first interconnection 21 and the second interconnection 22 in a two-layer interconnection configuration.

FIG. 9 illustrates a portion of the interconnection 21a from the drain of the first switching device Q1 to the relay point PL1a and a portion of the interconnection 31a from the source to the relay point PVa.

Source electrodes 51a, drain electrodes 52a, and gate electrodes 53a are multiply formed substantially parallel to each other on the substrate 50. These electrodes form multiple MOSFETs 54 including a not-illustrated gate dielectric film and a not-illustrated semiconductor layer below these electrodes. The interconnection 31a is electrically connected to the source electrodes 51a by via plugs 56. The interconnection 21a is electrically connected to the drain electrodes 52a by via plugs 55.

Thus, a large current can be handled by forming multiple MOSFETs connected in parallel.

Although not illustrated, the second switching device Q2 is disposed in a similar configuration symmetrically to the first switching device Q1 in the same plane substantially parallel to the interconnection 21a.

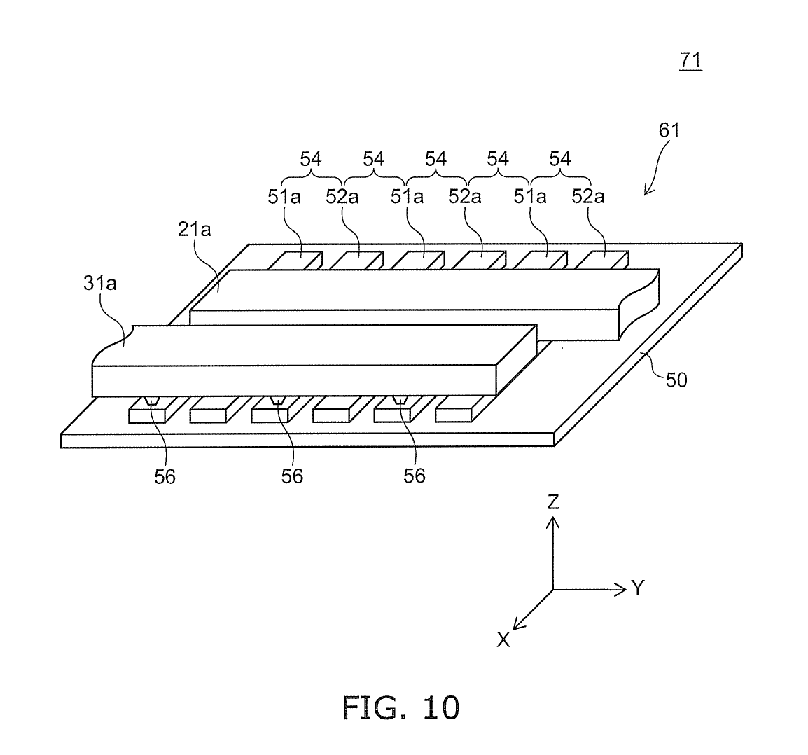

FIG. 10 is a schematic view illustrating the configuration of electrode portions of the switching devices illustrated in FIG. 3.

The two-layer interconnection configuration example in FIG. 10 illustrates a portion of the interconnection 21a from the drain of the first switching device Q1 to the relay point PL1a and a portion of the interconnection 31a from the source to the relay point PVa.

The source electrodes 51a and the drain electrodes 52a are multiply formed substantially parallel to each other on the substrate. The gate electrodes 53a, the gate dielectric film, and the semiconductor layer are not illustrated. The source electrode 51a and the drain electrode 52a form one MOSFET 54. The interconnection 31a is electrically connected to the source electrodes 51a by the via plugs 56. The interconnection 21a is electrically connected to the drain electrodes 52a by the via plugs 55 (not illustrated).

Thus, a large current can be handled by forming multiple MOSFETs connected in parallel.

Although not illustrated, the second switching device Q2 is disposed in a similar configuration symmetrically to the first switching device Q1 in the same plane substantially parallel to the interconnection 21a.

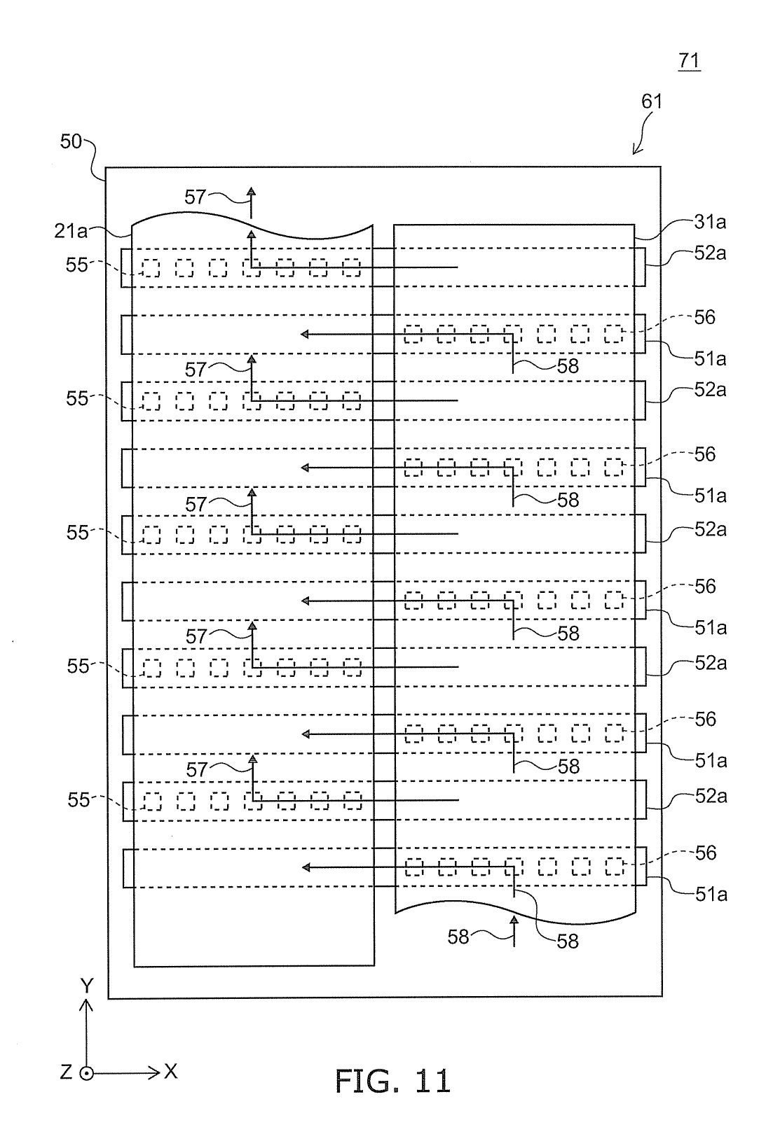

FIG. 11 is a schematic plan view illustrating the current paths of the electrode portions illustrated in FIG. 10.

The current flowing in the drain electrodes 52a multiply disposed substantially parallel to each other in FIG. 11 collects in the interconnection 21a through the via plugs 55. Similarly, current flows into the source electrodes 51a from the interconnection 31a through the via plugs 56. The drain current flows in the interconnection 21a in the direction of the arrows 57. The source current flows in the direction of the arrows 58, i.e., the same direction as the drain current.

Although not illustrated, the second switching device Q2 is disposed in a similar configuration symmetrically to the first switching device Q1 in the same plane substantially parallel to the interconnection 21a. The drain current of the second switching device Q2 flows parallel to the arrows 57 illustrated in FIG. 11. The drain current of the second switching device Q2 and the regenerative current Tout of the parasitic diode D2 flow in the same direction as the arrows 57, while the cross current (the reverse recovery current) Iᵣᵣ flows in the reverse direction of the arrows 57.

The current change dI/dt of the drain current I of the first switching device Q1 flowing in the direction of the arrows 57 produces a reverse electromotive force proportional to the mutual inductance M₁₂ in the drain interconnection of the second switching device Q2 and can suppress the cross current (the reverse recovery current) Iᵣᵣ.

According to this example, a semiconductor apparatus can be provided having reduced energy losses of the switching circuit controlling the inductive load.

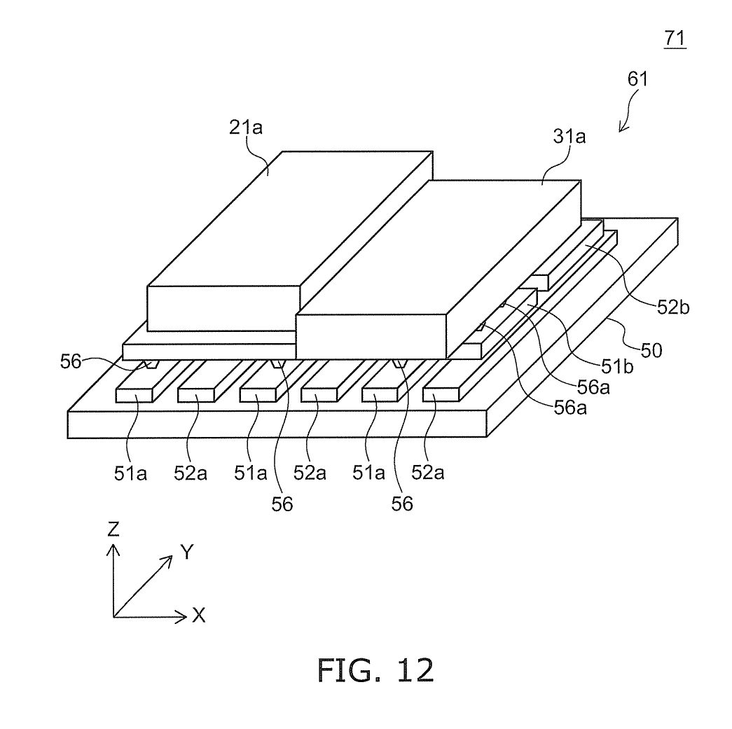

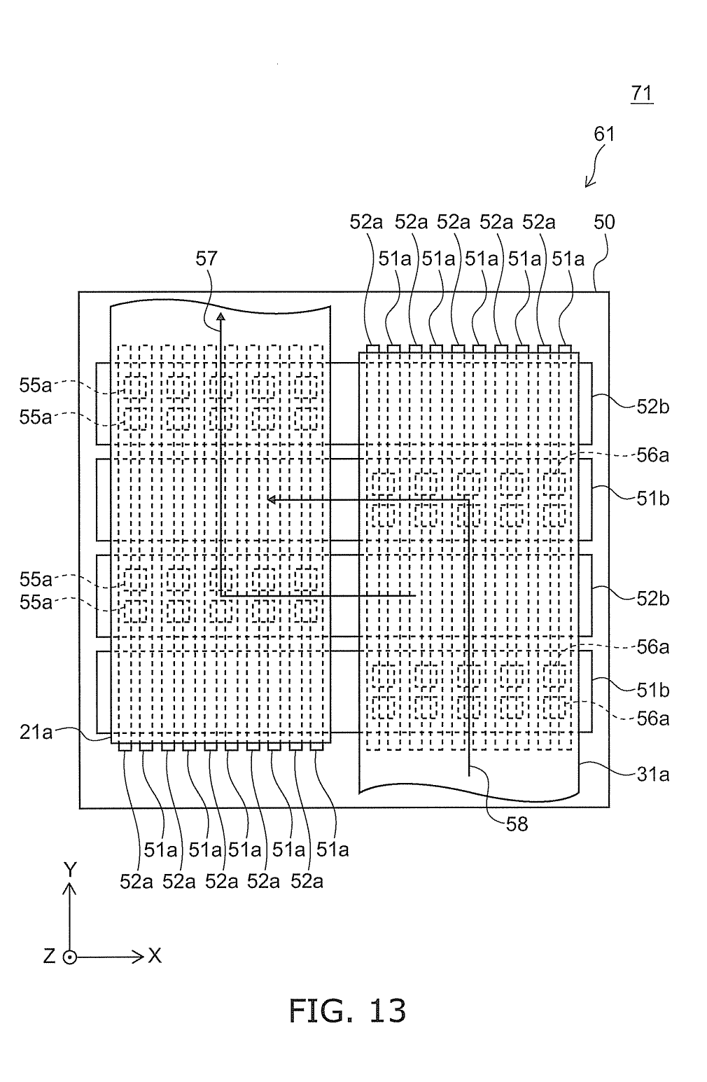

FIG. 12 is a schematic view illustrating another configuration of electrode portions of the switching devices illustrated in FIG. 3.

As illustrated in FIG. 12, the electrode portions, the first interconnection 21, and the second interconnection 22 may have a three-layer interconnection configuration.

FIG. 12 illustrates a portion of the interconnection 21a from the drain of the first switching device Q1 to the relay point PL1a and a portion of the interconnection 31a from the source to the relay point PVa.

Source electrodes 51a, drain electrodes 52a, and gate electrodes 53a (not illustrated) are multiply formed substantially parallel to each other on the substrate. These electrodes form multiple MOSFETs including a not-illustrated gate dielectric film and a not-illustrated semiconductor layer below these electrodes. The source electrodes 51b and the drain electrodes 52b of the second layer are formed substantially parallel to each other on either side of the not-illustrated dielectric film. The source electrodes 51b are electrically connected to the source electrodes 51a by the via plugs 56. Similarly, the drain electrodes 52b are electrically connected to the drain electrodes 52a by the not-illustrated via plugs 55.

The interconnection 31a is electrically connected to the source electrode 51b by the via plugs 56a. The interconnection 21a is electrically connected to the drain electrodes 52b by the via plugs 55a (not illustrated). The interconnection 31a is electrically connected to the source electrodes 51a. The interconnection 21a is electrically connected to the drain electrodes 52a.

Thus, an even larger current can be handled by forming multiple MOSFETs connected in parallel.

Although not illustrated, the second switching device Q2 is disposed in a similar configuration symmetrically to the first switching device Q1 in the same plane substantially parallel to the interconnection 21a.

FIG. 13 is a schematic plan view illustrating the current paths of the electrode portions of the switching devices illustrated in FIG. 12.

As illustrated in FIG. 13, the current flowing in the drain electrodes 52a multiply disposed parallel to each other collects in the drain electrodes 52b through the via plugs 55 (not illustrated) and further collects in the interconnection 21a through the via plugs 55a. Similarly, the current flowing in the source electrodes 51a collects in the source electrode 51b through the via plugs 56 (not illustrated) and further collects in the interconnection 31a through the via plugs 56a. The drain current flows in the interconnection 21a in the direction of the arrow 57. The source current flows in the direction of the arrow 58 in the same direction as the drain current.

Although not illustrated, the second switching device Q2 is disposed in a similar configuration symmetrically to the first switching device Q1 in the same plane substantially parallel to the interconnection 21a. The drain current of the second switching device Q2 flows parallel to the arrow 57 illustrated in FIG. 13. The drain current of the second switching device Q2 and the regenerative current Tout of the parasitic diode D2 flow in the same direction as the arrow 57, while the cross current (the reverse recovery current) Iᵣᵣ flows in the reverse direction of the arrow 57.

The current change dI/dt of the drain current I of the first switching device Q1 flowing in the direction of the arrow 57 produces a reverse electromotive force proportional to the mutual inductance M₁₂ in the drain interconnection of the second switching device Q2 and can suppress the cross current (the reverse recovery current) Iᵣᵣ.

According to this example, a semiconductor apparatus can be provided having reduced energy losses of the switching circuit controlling the inductive load.

Hereinabove, examples are illustrated in which the interconnection 21a and the interconnection 31a are in the same plane and the interconnection 21a and the interconnection 22a (not illustrated) are aligned in the same plane substantially parallel to each other. However, the interconnection 21a and the interconnection 22a are not limited thereto and may be, for example, disposed on either side of an dielectric film and aligned substantially parallel to each other between layers.

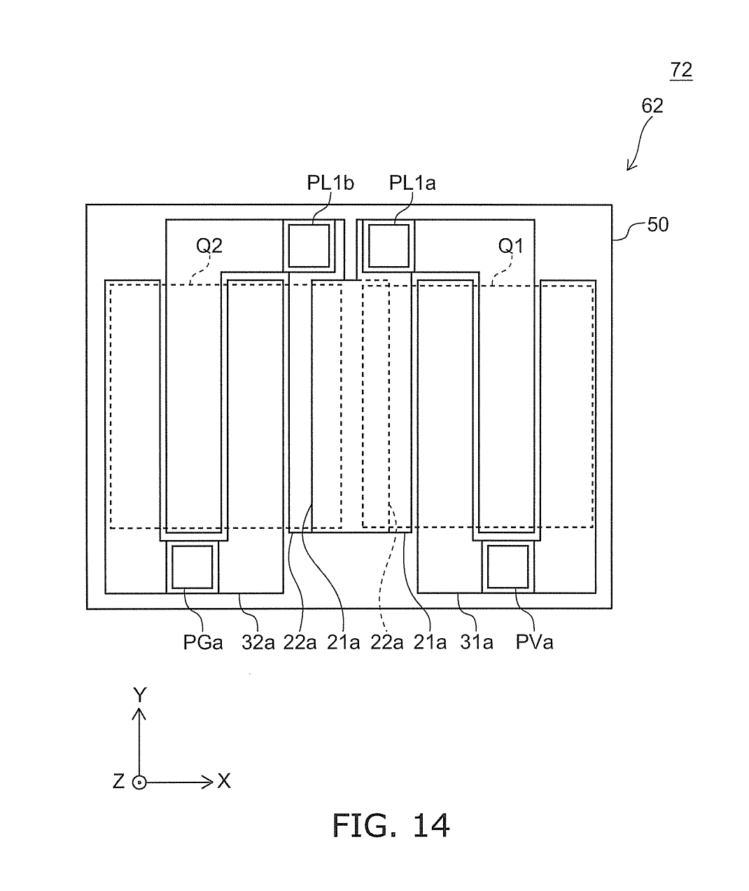

FIG. 14 is a schematic plan view illustrating another configuration of electrode portions of the switching devices of the integrated circuit (the semiconductor apparatus) illustrated in FIG. 2.

In an integrated circuit 62 (semiconductor apparatus) sealed in a semiconductor apparatus 72 illustrated in FIG. 14, a first switching device Q1 and a second switching device Q2 are disposed symmetrically to each other.

The plane parallel to the electrode units is assumed to be the XY plane. The axis of symmetry centered between the first switching device Q1 and the second switching device Q2 is assumed to be the Y axis. The direction perpendicular to the Y axis from the second switching device Q2 toward the first switching device Q1 is assumed to be the X axis.

The interconnection 21a and the interconnection 22a are formed symmetrically with respect to the Y axis and parallel to each other in the Y direction. The interconnection 21a and the interconnection 22a are disposed on either side of an dielectric film and are aligned parallel to each other between the layers such that portions thereof oppose each other. That is, the interconnection 21a and the interconnection 22a are provided substantially parallel to each other. The mutual inductance M₁₂ between the interconnections is thereby increased. Otherwise, the integrated circuit 62 and the semiconductor apparatus 72 are similar to the integrated circuit 61 illustrated in FIG. 3 and the semiconductor apparatus 71 in which the integrated circuit 61 is sealed, and a description is omitted.

Thereby, a reverse voltage proportional to the mutual inductance M₁₂ is produced, and the cross current (the reverse recovery current) Iᵣᵣ can be suppressed.

According to this example, a semiconductor apparatus can be provided having reduced energy losses of the switching circuit controlling the inductive load.

Although the case where the first switching device Q1 and the second switching device Q2 are disposed symmetrically to each other is illustrated in this example, the present invention is not limited thereto. It is sufficient that the interconnection 21a and the interconnection 22a are proximal and substantially parallel between layers. Although the interconnections 21a, 31a, 22a, and 32a illustrated in FIG. 14 is U-shaped, configurations are possible in which I-shapes, L-shapes, or other configurations are disposed substantially parallel to each other. The first switching device Q1 and the second switching device Q2 may have different configurations.

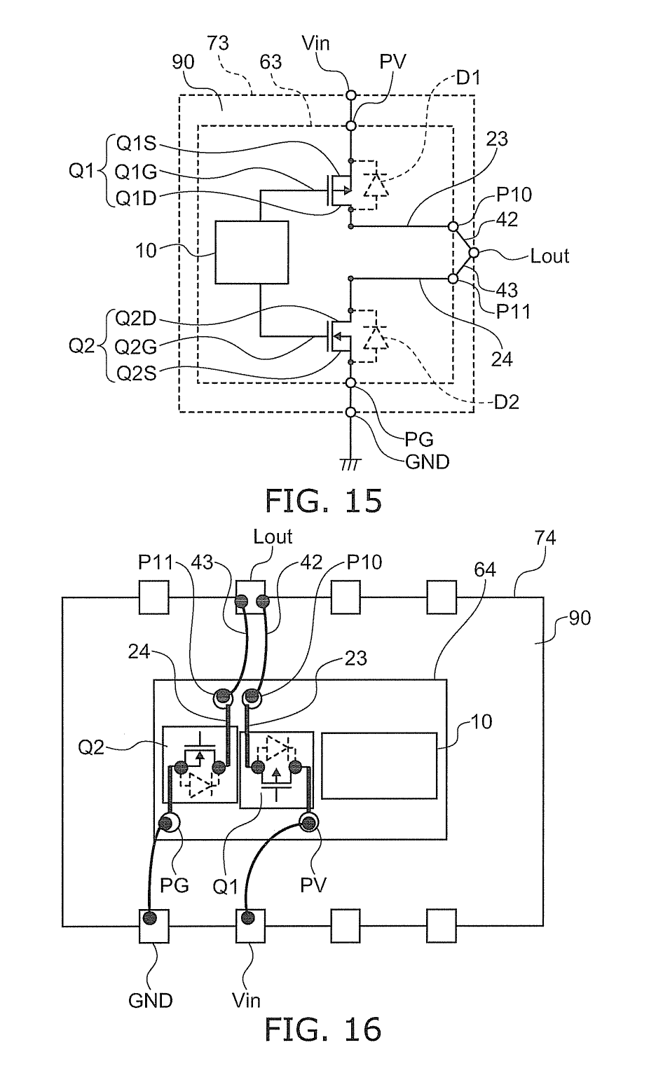

FIG. 15 is a schematic view illustrating the configuration of a semiconductor apparatus according to a second embodiment of the present invention.

A semiconductor apparatus 73 illustrated in FIG. 15 is a switching circuit similar to the semiconductor apparatus 70 illustrated in FIG. 1 including switching devices Q1 and Q2 high and low side. The semiconductor apparatus 73 can drive an inductive load and may be used as, for example, a DC-DC converter.

The semiconductor apparatus 73 includes a external terminal Lout, an integrated circuit 63 (semiconductor apparatus), a third interconnection 42, a fourth interconnection 43, and a package 90. The third interconnection 42 electrically connects a bonding pad P10 (the first driving terminal) of the integrated circuit 63 described below to the external terminal Lout exposed to the exterior of the package 90. The third interconnection 42 is formed of, for example, a bonding wire. Similarly, the fourth interconnection 43 electrically connects a bonding pad P11 (the second driving terminal) to the external terminal Lout. The semiconductor apparatus 73 has a structure in which the package 90 contains the external terminal Lout, the integrated circuit 63, the third interconnection 42, and the fourth interconnection 43 by, for example, sealing in resin or sealing in a can, ceramic housing, etc.

The integrated circuit 63 has a one-chip structure including the first switching device Q1, the second switching device Q2, the control circuit 10, the bonding pad P10 (the first driving terminal), the bonding pad P11 (the second driving terminal), the first interconnection 23, and the second interconnection 24 formed on the same semiconductor substrate.

The integrated circuit 63 illustrated in FIG. 15 may include other circuits, devices, and interconnections.

A drain Q1D of the first switching device Q1 is electrically connected to the bonding pad P10 (the first driving terminal) by the first interconnection 23. A drain Q2D of the second switching device Q2 is electrically connected to the bonding pad P11 (the second driving terminal) by the second interconnection 24. Otherwise, the semiconductor apparatus 73 is similar to the semiconductor apparatus 70 illustrated in FIG. 1, and a description is omitted.

Although two bonding pads are provided and the number of bonding wires increases thereby to two, the mutual inductance also increases by the amount by which the parallel interconnections lengthen.

Thereby, a large reverse electromotive force is produced, and the cross current (the reverse recovery current) Iᵣᵣ can be suppressed.

According to this example, a semiconductor apparatus can be provided having reduced energy losses of the switching circuit controlling the inductive load.

Although two bonding pads P10 and P11 are provided in the integrated circuit 63 illustrated in this example, the present invention is not limited thereto. Two or more multiple bonding pads may be provided. The mutual inductance M₁₂ between the interconnections can be further increased by providing multiple interconnections to the two levels of switching devices above and below.

The mutual inductance M₁₂ between the interconnections also can be further increased by providing multiple interconnections from the two or more multiple bonding pads to the external terminal Lout.

Thereby, a semiconductor apparatus can be provided to produce a large reverse electromotive force, suppress the cross current (the reverse recovery current) Iᵣᵣ, and reduce the energy losses of the switching circuit controlling the inductive load.

FIG. 16 is a schematic view illustrating another configuration of the semiconductor apparatus according to the second embodiment of the present invention.

As illustrated in FIG. 16, an integrated circuit 64 (semiconductor apparatus) is sealed in the semiconductor apparatus 74 such that A drain of a first switching device Q1 and a drain of a second switching device Q2 are disposed proximally to each other.

The integrated circuit 64 includes a first interconnection 23 electrically connecting the drain of the first switching device Q1 to a bonding pad P10 (a first driving terminal). The integrated circuit 64 also includes a second interconnection 24 electrically connecting the drain of the second switching device Q2 to a bonding pad P11 (a second driving terminal).

In the integrated circuit 64, the first interconnection 23 or at least a portion thereof and the second interconnection 24 or at least a portion thereof are provided substantially parallel to each other. The mutual inductance M₁₂ between the first interconnection 23 and the second interconnection 24 can thereby be increased. Otherwise, the semiconductor apparatus 74 is similar to the semiconductor apparatus 73 illustrated in FIG. 15, and a description is omitted.

By increasing the mutual inductance M₁₂ between the first interconnection 23 and the second interconnection 24, a reverse voltage proportional to the mutual inductance M₁₂ is produced and the cross current (the reverse recovery current) Iᵣᵣ can be suppressed.

According to this example, a semiconductor apparatus can be provided having reduced energy losses of the switching circuit controlling the inductive load.

FIG. 17 is a circuit diagram illustrating the configuration of a DC-DC converter using a semiconductor apparatus according to a third embodiment of the present invention.

A DC-DC converter 81 illustrated in FIG. 17 (illustrated as a voltage step-down converter in the drawing) supplies a voltage to a load and includes a semiconductor apparatus 75, a coil H1, and a capacitor C1. Similarly to FIG. 1, the load is represented as a load resistor R1. One end of the coil H1 connects to the external terminal Lout of the semiconductor apparatus 75. The other end of the coil H1 is terminated by the capacitor C1 and the load resistor R1.

The DC-DC converter 81 is a voltage step-down DC-DC converter and outputs a voltage Vout lower than an input Vin by switching a first switching device Q1 included in the semiconductor apparatus 75 ON and OFF.

The semiconductor apparatus 75 illustrated in FIG. 17 (a portion enclosed by a broken line) includes a external terminal Lout, an integrated circuit 65 (semiconductor apparatus), a third interconnection 41, and a package 90. The third interconnection 41 electrically connects the bonding pad PL1 (the first driving terminal) of the integrated circuit 65 described below to the external terminal Lout exposed to the exterior of the package 90. The third interconnection 41 is formed of, for example, a bonding wire. The semiconductor apparatus 75 has a structure in which the package 90 contains the external terminal Lout, the integrated circuit 65, and the third interconnection 41 by, for example, sealing in resin or sealing in a can, ceramic housing, etc.

The integrated circuit 65 has a configuration in which the second switching device Q2 of the integrated circuit 60 illustrated in FIG. 1 is replaced by a diode D10 (rectifying device). The integrated circuit 65 has a one-chip structure including a control circuit 11, a bonding pad PL1 (the first driving terminal), a first interconnection 21, and a second interconnection 22 formed on a same semiconductor substrate.

The integrated circuit 65 illustrated in FIG. 17 may include other circuits, devices, and interconnections.

The control circuit 11 controls by switching the first switching device Q1 ON and OFF to store and maintain the necessary energy in the coil H1.

Otherwise, the semiconductor apparatus 75 and the DC-DC converter 81 are similar to the semiconductor apparatus and the DC-DC converter 80 using the semiconductor apparatus 70 illustrated in FIG. 1, and a description is omitted.

Although the second switching device Q2 is replaced by the diode D10 (the rectifying device) in the semiconductor apparatus 75 (a portion enclosed by a broken line) illustrated in FIG. 17, the mutual inductance M₁₂ between the first interconnection 21 and the second interconnection 22 produces a reverse voltage proportional to the mutual inductance M₁₂ similarly to the semiconductor apparatus 70 illustrated in FIG. 1 and can suppress the cross current (the reverse recovery current) Iᵣᵣ.

Returning once again to FIGS. 6A to 6C, the case of FIG. 6A where the first switching device Q1 is OFF and the second switching device Q2 is ON and the case of FIG. 6B where the first switching device Q1 is OFF and the second switching device Q2 is OFF correspond to the case of FIG. 17 where the first switching device Q1 is OFF and the regenerative current Tout flows through the diode D10.

The state of FIG. 6C where the first switching device Q1 is switched from OFF to ON similarly corresponds to the state of FIG. 17 where the first switching device Q1 is switched from OFF to ON. Also in the semiconductor apparatus 75 illustrated in FIG. 17, the cross current (the reverse recovery current) Iᵣᵣ flows at this time and energy losses result. In the case of a DC-DC converter, the losses appear as an efficiency decrease.

Accordingly, in the semiconductor apparatus 75 as well, the mutual inductance M₁₂ between the first interconnection 21 and the second interconnection 22 produces a reverse voltage proportional to the mutual inductance M₁₂, and the cross current (the reverse recovery current) Iᵣᵣ can be suppressed.

The semiconductor apparatus 75 reduces energy losses of the switching circuit controlling the inductive load.

The control circuit 11 of the semiconductor apparatus 75 is a circuit controlling the first switching device Q1 excluding the circuit portion of the control circuit 10 illustrated in FIG. 1 controlling the second switching device Q2. However, the control circuit 10 may be used as the control circuit 11.

Hereinabove, examples are described in which the examples of the present invention are used in DC-DC converters. However, the present invention is not limited thereto. Examples may be used in switching circuits controlling inductive loads.

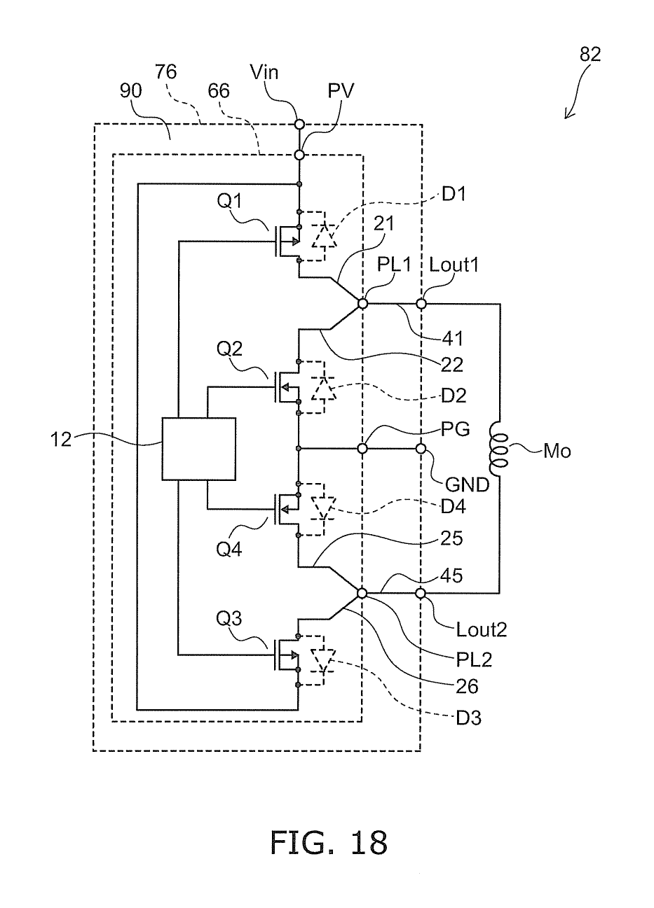

FIG. 18 is a circuit diagram illustrating the configuration of a motor control circuit using a semiconductor apparatus according to a fourth embodiment of the present invention.

A motor control circuit 82 illustrated in FIG. 18 controls a motor Mo.

A semiconductor apparatus 76 illustrated in FIG. 18 (a portion enclosed by a broken line) includes two external terminals Lout1 and Lout2, an integrated circuit 66 (semiconductor apparatus), two third interconnections 41 and 45, and a package 90. The third interconnection 41 electrically connects a bonding pad PL1 (a first driving terminal) of the integrated circuit 66 described below to the external terminal Lout1 exposed to the exterior of the package 90. The third interconnection 41 is formed of, for example, a bonding wire. Similarly, the third interconnection 45 electrically connects the bonding pad PL2 (the first driving terminal) to the external terminal Lout2. The semiconductor apparatus 76 has a structure in which the package 90 contains the two external terminals Lout1 and Lout2, the integrated circuit 66, and the two third interconnections 41 and 45 by, for example, sealing in resin or sealing in a can, ceramic housing, etc.

The integrated circuit 66 includes two switching circuits connected in series and formed of the first switching device Q1 and the second switching device Q2 of the integrated circuit 60 illustrated in FIG. 1. The integrated circuit 66 has a one-chip structure including two first switching devices Q1 and Q3, two second switching devices Q2 and Q4, a control circuit 12, two bonding pads PL1 and PL2 (the first driving terminals), two first interconnections 21 and 25, and two second interconnections 22 and 26 formed on a same semiconductor substrate.

The integrated circuit 66 illustrated in FIG. 18 may include other circuits, devices, and interconnections.

The external terminal Lout1 of the semiconductor apparatus 76 is electrically connected to a connection point between the first switching device Q1 and the second switching device Q2 connected in series. The external terminal Lout1 is electrically connected to the input Vin when the first switching device Q1 is switched ON. The external terminal Lout1 is electrically connected to ground GND when the second switching device Q2 is switched ON.

Similarly, the external terminal Lout2 is electrically connected to a connection point between the first switching device Q3 and the second switching device Q4 connected in series. The external terminal Lout2 is electrically connected to the input Vin when the first switching device Q3 is switched ON. The external terminal Lout2 is electrically connected to ground GND when the second switching device Q4 is switched ON.

The external terminals Lout1 and Lout2 supply energy to the motor Mo.

One set is formed of the first interconnection 21 electrically connecting the first switching device Q1 to the bonding pad PL1 and the second interconnection 22 electrically connecting the second switching device Q2 to the bonding pad PL1. Similarly, another set is formed of the first interconnection 25 electrically connecting the first switching device Q3 to the bonding pad PL2 and the second interconnection 26 electrically connecting the second switching device Q4 to the bonding pad PL2.

The first interconnection 21 or at least a portion thereof and the second interconnection 22 or at least a portion thereof are provided proximally to each other to increase the mutual inductance M₁₂. Similarly, the first interconnection 25 or at least a portion thereof and the second interconnection 26 or at least a portion thereof are provided proximally to each other to increase the mutual inductance M₁₂.

The control circuit 12 controls to supply a necessary energy to the motor Mo by switching the first switching device Q1 of the one set and the second switching device Q2 of the one set alternately ON and OFF and the first switching device Q3 of the other set and the second switching device Q4 of the other set alternately ON and OFF.

FIG. 18 illustrates the case where the first switching devices Q1 and Q3 include p-type MOSFETs. Similarly, the case is illustrated where the second switching devices Q2 and Q4 include n-type MOSFETs. The first switching devices Q1 and Q3 have parasitic diodes D1 and D3, respectively. The second switching devices Q2 and Q4 have parasitic diodes D2 and D4, respectively.

The control circuit 12 controls such that the first switching device Q3 of the other set is OFF and the second switching device Q4 of the other set is ON when the first switching device Q1 of the one set is ON and the second switching device Q2 of the one set is OFF. At this time, current flows from the power source Vin through the first switching device Q1 of the one set and from the external terminal Lout1 through the motor Mo. Current flows from the external terminal Lout2 through the second switching device Q4 of the other set to ground GND.

The control circuit 12 controls such that the first switching device Q3 of the other set is ON and the second switching device Q4 of the other set is OFF when the first switching device Q1 of the one set is OFF and the second switching device Q2 of the one set is ON. At this time, current flows from the power source Vin through the first switching device Q3 of the other set and from the external terminal Lout2 through the motor Mo. Current flows from the external terminal Lout1 through the second switching device Q2 of the one set to ground GND.

Thus, the motor Mo is controlled by controlling the amount and direction of the current flowing through the motor Mo.

To prevent cross current in such a semiconductor apparatus 76 as well, a state is provided where the first switching devices Q1 and Q3 and the second switching devices Q2 and Q4 are simultaneously OFF. The cross current (the reverse recovery current) Iᵣᵣ in the parasitic diodes D1 to D4 recited above is problematic when the first switching device Q1 or Q3 is switched from OFF to ON.

For example, the state is assumed where the first switching device Q1 of the one set is ON, the second switching device Q2 of the one set is OFF, the first switching device Q3 of the other set is OFF, and the second switching device Q4 of the other set is ON. Current flows through the motor Mo in the direction from the external terminal Lout1 through the motor Mo toward the external terminal Lout2.

The state is now assumed to change to where the first switching devices Q1 and Q3 and the second switching devices Q2 and Q4 are simultaneously OFF. A regenerative current continues to flow through the motor Mo in the direction from the external terminal Lout1 through the motor Mo toward the external terminal Lout2.

The regenerative current flows from ground GND through the parasitic diode D2 and from the external terminal Lout1 through the motor Mo. The regenerative current flows from the external terminal Lout2 through the parasitic diode D3 to the power source terminal Vin.

Here, a control is performed to once again provide current to the motor Mo in the same direction. The state is changed to where the first switching device Q1 of the one set is ON, the second switching device Q2 of the one set is OFF, the first switching device Q3 of the other set is OFF, and the second switching device Q4 of the other set is ON.

At this time, the cross current (the reverse recovery current) Iᵣᵣ flows in the first switching device Q1 and the parasitic diode D2 of the one set. Similarly, the cross current (the reverse recovery current) Iᵣᵣ flows in the second switching device Q4 and the parasitic diode D3 of the other set.

The cross current (reverse current) Iᵣᵣ flowing in the first switching device Q1 and the parasitic diode D2 of the one set will now be described.

As recited above, the first interconnection 21 from the first switching device Q1 to the bonding pad PL1 and the second interconnection 22 from the second switching device Q2 to the bonding pad PL1 of each set in the semiconductor apparatus 76 are provided to increase the mutual inductance M₁₂ between the interconnections. Therefore, a reverse electromotive force proportional to the mutual inductance M₁₂ is produced, and the cross current (the reverse recovery current) Iᵣᵣ can be suppressed thereby.

The semiconductor apparatus 76 reduces energy losses of the switching circuit controlling the inductive load.

The case where current flows through the motor Mo in the reverse direction is similar thereto.

Although the motor Mo is illustrated as only one coil in FIG. 18, the present invention is not limited thereto. For example, multiple coils may be controlled by providing multiple switching circuits according to the number of coils. For example, a three-phase motor and the like can be controlled similarly.

The motor Mo of this example is illustrated as a specific example of the inductive load and therefore includes actuators. An actuator may be controlled by providing positions and speeds detected by not-illustrated position detection and speed detection circuits as feedback to the control circuit 12. In other words, it is possible to control an inductive load converting electrical energy to mechanical energy, e.g., actuators such as motors, solenoids, etc.

The first switching devices Q1 and Q3 and the second switching devices Q2 and Q4 are not limited to those of this example and may include other devices, e.g., n-type MOSFETs used together, p-type MOSFETs used together, a BJT, an IGBT, or a bipolar transistor.

The integrated circuits 60 to 64 of the examples recited above may be used as the first switching devices Q1 and Q3, the second switching devices Q2 and Q4, the first interconnections 21 and 25, the second interconnections 22 and 26, and the bonding pads PL1 and PL2 of the sets.

The inductive load including the coil H1 and the like often is larger than the semiconductor chip and therefore is not included in the package; and the semiconductor apparatuses 70 to 74 such as a portion enclosed by a broken line in FIG. 1 are sealed by, for example, resin. However, the present invention is not limited thereto. The present invention may be practiced also for a configuration in which, for example, the coil H1 illustrated, in FIG. 1 is sealed in the semiconductor apparatus.

Hereinabove, exemplary embodiments of the present invention are described with reference to specific examples. However, the present invention is not limited to these specific examples. For example, one skilled in the art may appropriately select specific configurations of components of semiconductor apparatuses from known art and similarly practice the present invention. Such practice is included in the scope of the present invention to the extent that similar effects thereto are obtained.

Further, any two or more components of the specific examples may be combined within the extent of technical feasibility; and are included in the scope of the present invention to the extent that the purport of the present invention is included.

Moreover, all semiconductor apparatuses obtainable by an appropriate design modification by one skilled in the art based on the semiconductor apparatuses described above as exemplary embodiments of the present invention also are within the scope of the present invention to the extent that the purport of the present invention is included.

Furthermore, various modifications and alterations within the spirit of the present invention will be readily apparent to those skilled in the art. All such modifications and alterations should therefore be seen as within the scope of the present invention.

1. A semiconductor apparatus, comprising:
a first switching device;
a rectifying device;
a control circuit controlling the first switching device;
a first driving terminal;
a first interconnection connecting the first switching device to the first driving terminal; and
a second interconnection disposed to connect the rectifying device to the first driving terminal, the second interconnection having a mutual inductance with the first interconnection.

2. A semiconductor apparatus, comprising:
a package containing a first switching device, a rectifying device, a control circuit controlling the first switching device, a first driving terminal, a first interconnection connecting the first switching device to the first driving terminal, and a second interconnection disposed to connect the rectifying device to the first driving terminal, the second interconnection having a mutual inductance with the first interconnection;
an external terminal exposed to an exterior of the package; and
a third interconnection connecting the first driving terminal to the external terminal.

3. The apparatus according to claim 1 or 2, further comprising a second switching device connected in parallel with the rectifying device and controlled by the control circuit.

4. The apparatus according to claim 3, wherein the rectifying device is a parasitic diode of the second switching device.

5. The apparatus according to claim 1, further comprising:
a second driving terminal,
the second interconnection being connected to the rectifying device and the second driving terminal.

6. The apparatus according to claim 1 or 2, wherein the first interconnection and the second interconnection are aligned substantially parallel to each other in the same plane.

7. The apparatus according to claim 1 or 2, further comprising:
a dielectric film,
the first interconnection and the second interconnection being aligned substantially parallel to each other on either side of the dielectric film.

8. The apparatus according to claim 2, further comprising:
a fourth interconnection connecting the second driving terminal to the external terminal,
the package further containing a second driving terminal,
the second interconnection being connected to the rectifying device and the second driving terminal.
